(19) United States
(12) Patent Application Publication
(10) Pub. No.: US 2003/0222406 A1
(43) Pub. Date: Dec. 4, 2003

(54) Sealing cap assembly on ball-and-socket joint

(76) Inventor: Marcos Vieira Capuchim, Sao Caetano Do Sul (BR)

Correspondence Address: LINIAK, BERENATO, LONGACRE & WHITE, Suite 240, 6550 Rock Spring Drive, Bethesda, MD, 20817, US

(21) Appl. No.: 10/394,647

(22) Filed: Mar. 24, 2003

(30) Foreign Application Priority Data
Mar. 22, 2002 (BR) PI 0201128-0

(51) Int. Cl. F16J 15/36

(52) U.S. Cl. 277/392

(57) ABSTRACT

A sealing cap on ball-and-socket joint made of elastomer with openings on both ends, a first one of larger diameter to be coupled to the top of the ball-and-socket joint case and a second one of smaller diameter to be coupled to the body of the spherical end pin. The conventional sealing ring is eliminated by making a channel on the top of the ball-and-socket joint case that has a deformable external flap or flaps to fix this opening of larger diameter of the sealing cap inside the channel provided on the top of the ball-and-socket joint case. The sealing system provides an improved sealing to the system and fastening the sealing cap to the inside of the channel, which, consequently, makes difficult the entry of any impurity inside the ball-and-socket joint and does not allow the sealing cap from getting loose from its mounting position.

### BACKGROUND OF THE INVENTION

1. Field of the Invention

This invention relates to a sealing cap fixing system on a ball-and-socket joint that is applied in a connection that requires angular and rotational movement of two pieces, more specifically, for application in automotive vehicles.

2. Description of Related Art

The ball-and-socket joints intended for automotive vehicles require a sealing system to prevent impurities such as dust, sand and water from penetrating into the interior and prematurely wearing out the components. Because these pieces function by the coupling of their components, they must have the best possible conformation, as after the mounting of the coupled set, a certain displacement load on the moving parts is applied. The load is produced by the friction between these moving parts. Consequently, the existence of impurities between the friction parts tends to cause a premature wearing out of the components and jeopardizes the proper functioning of the ball-and-socket joint.

The conventional ball-and-socket joints normally comprise a pin with one of its ends having spherical shape, that is coupled to a bearing, single or in two pieces, and the set is mounted inside a case that, afterwards, has the orifice, through which the spherical pin and the bearing were mounted, sealed by a cap attached to the case, so as to prevent the entry of any impurity. At the end of the case, opposed to the closing cap, the non-spherical part of the pin is protruded through an opening, where one of the pieces (e.g., a tie rod arm) that require angular and rotational movement must be attached, the other piece being (e.g., vehicle body component) fixed to the case of the ball-and-socket joint. Thus, the angular and rotational movement provided between the spherical pin and the housing of the ball-and-socket joint must meet the needs of the parts that are connected therein.

However, as in the sealing of the case by the cap disposed to prevent the entry of impurities inside the ball-and-socket joint, in the opposite end, through which the body of the spherical pin is protruded, the sealing system must be effective and efficient, even more because it is in this place that the spherical pin moves angular and rotationally in relation to the case. The state of the art anticipates providing this place with a sealing system that consists of a cap or boot made of elastomer, with the two ends open, one of larger diameter to be coupled to the external part of the case and another of smaller diameter to be coupled to the body of the spherical pin. In the external part coupling of the case, the fixing of the sealing cap normally is made in a channel existing there, where the end of larger diameter of the sealing cap is placed, overlapping afterwards an elastic ring on it, intended to fix the sealing cap on the case and prevent the entry of any impurity. In the coupling of the spherical pin body is provided another ring, which is intended to firmly fix the sealing cap on the body of the spherical pin, preventing the entry of impurities but not without allowing its rotational movement.

The system of fixing the sealing cap on the ball-and-socket joint, however, has shown some undesirable effects, related to the efficiency of the sealing, to the high cost resulting from the component utilization, tension ring to fasten the sealing cap, and even to the very manufacturing difficulties of the system, related to the mounting of the tension rings in the ball-and-socket joints, where damages to the sealing cap may occur.

### SUMMARY OF THE INVENTION

This invention eliminates the undesirable effects present in the prior art by providing the system with a construction of a channel where the larger diameter end of the sealing cap is placed. That is, the invention proposed to machine a channel on the top of the ball-and-socket joint case, namely, at the side of the opening through where the body of the spherical head pin is protruded, so as to keep the external flap of the channel. The flap that is adjacent to the external circumference of the ball-and-socket joint, with shape and dimensions, with their own thickness and height, being subjected to deformation when mounting the sealing cap.

Thus, the fixing of the sealing cap in the ball-and-socket joint will be made by connecting the opening of larger diameter of the sealing cap in the channel made on the top of the case, deforming, afterwards on this end of the sealing cap, the external flap of the channel. This construction eliminates the tension ring and provides an effective connection of the larger diameter end of the sealing cap with the case of the ball-and-socket joint, in such a way that the sealing cap will not loosen from the mounting place due to the external flap deformation of the channel on it. The system provides a sealing of the set preventing the entry of any impurity inside the ball-and-socket joint, having in mind the close cooperation of the material of the sealing cap itself, that is pressed inside the channel by the deformation of its external flap.

### BRIEF DESCRIPTION OF THE DRAWINGS

Next, this invention is detailed, showing the description of a preferred embodiment shown in the attached drawings, where:

FIG. 1 shows, in a cross section view, the sealing cap;

FIG. 2 shows in a cross section view the ball-and-socket joint without the sealing cap, where the fixing channel is seen; and,

FIG. 3 shows in a cross section view the sealing cap coupled to the ball- and-socket joint with the external flap of the case channel deformed on the sealing cap.

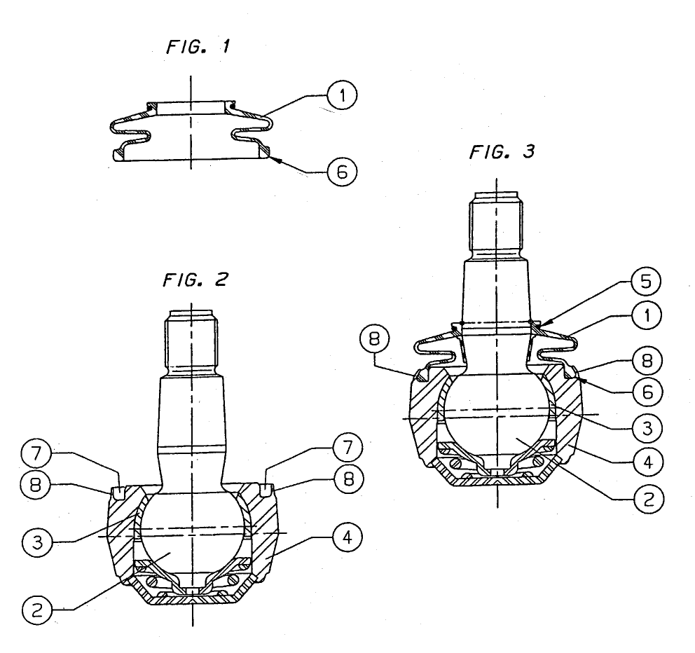

### DETAILED DESCRIPTION OF THE PREFERRED EMBODIMENTS

The Figures show, in the preferred embodiment of the invention, the sealing cap (1), and a ball-and-socket joint, comprising a pin with one spherical ball end (2), that is coupled to a bearing (3), which is formed as a single piece or in two pieces, with these components mounted inside a case (4). The sealing cap (1) mounted in the non-spherical end of the spherical end (2) has in the smaller diameter opening a sealing ring (5) fixing it to the body of the spherical end pin (2) providing the sealing of the system, preventing the entry of any impurity inside the ball-and-socket joint, but assuring the desired rotational movement for the spherical ball end (2). The sealing cap (1) in the larger diameter end, has a sealing lip (6), that is mounted inside the channel (7), made in the top of the case (4). In the mounting process, the external flap (8) of the channel (7) is press-fit or deformed on the sealing lip (6) of the sealing cap (1). This deformation involves the sealing lip (6), so that the lip (6) is pressed against the inside of the channel (7) of the case (4) firmly adhering to it and providing the necessary sealing. At the same time, this external flap (8) of the channel (7) closes against the sealing lip (6) fixing the sealing cap (1) inside the channel (7), thereby preventing the lip (6) from getting loose from its mounting place.

With this invention, the fixing of the sealing cap in the ball-and-socket joint will be made by connecting the opening of larger diameter of the sealing cap in the channel made on the top of the case, deforming, afterwards on this end of the sealing cap, the external flap of the channel. This construction eliminates the tension ring and provides an improved connection of the larger diameter end of the sealing cap with the case of the ball-and-socket joint, in such a way that the sealing cap will not loosen from the mounting place due to the external flap deformation of the channel on it. The system provides a sealing of the set preventing the entry of any impurity inside the ball-and-socket joint, having in mind the close cooperation of the material of the sealing cap itself, that is pressed inside the channel by the deformation of its external flap.

While the foregoing invention has been shown and described with reference to a preferred embodiment, it will be understood by those of skill in the art that various changes in form and detail may be made therein without departing from the spirit and scope of this invention. For example, the flap (8) is shown as a continuous ridge; however, the flap (8) may be designed as a series of bendable tangs (non-continuous) that are disposed outside the lip (6) whereby the bendable or deformable tangs may be deformed to fix the lip (6) within the channel (7).

1. A ball and socket assembly for fixing a sealing cap on a ball-and-socket joint, comprising:
a case for receiving a spherical ball end of a pin member; and
a sealing cap made of elastomer with two open ends, a first end of larger diameter to be coupled to an external part of said case of said ball-and-socket joint and a second end of smaller diameter adapted to be coupled to a body of said pin member, wherein the sealing cap has a sealing lip that is coupled to a channel formed on a side of said case.

2. The ball and socket assembly of claim 1, wherein said channel is formed at a side of said case having an opening through which the pin member is protruded.

3. The ball and socket assembly of claim 1, wherein the channel has an external flap circumscribing at least a portion of said sealing lip, wherein in the mounting process the external flap is deformed on the sealing lip of the sealing cap

4. The ball and socket assembly of claim 1, wherein, when the external flap of the channel is pressed against the sealing lip of the sealing cap, the sealing lip is compressed inside the channel provided at the top of the case, providing a sealing to the system and fixing the sealing cap inside the channel to thereby reduce impurities inside the ball-and-socket joint.

5. The ball and socket assembly of claim 3, wherein the external flap continuously circumscribes said sealing lip.

6. The ball and socket assembly of claim 3, wherein the external flap is disposed at discrete locations about said sealing lip.
